(19) United States
(12) Patent Application Publication
(10) Pub. No.: US 2010/0036578 A1
(43) Pub. Date: Feb. 11, 2010

(54) AUTOMATIC OPERATION CONTROL APPARATUS, AUTOMATIC OPERATION CONTROL METHOD,VEHICLE CRUISE SYSTEM, AND METHOD FOR CONTROLLING THE VEHICLE CRUISE SYSTEM

(75) Inventors: Koji Taguchi, Isehara-shi (JP); Tomoyuki Doi, Gotenba-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI, AICHI-KEN (JP)

(21) Appl. No.: 12/312,224

(22) PCT Filed: Nov. 9, 2007
(86) PCT No.: PCT/IB2007/004223

§ 371 Date: Apr. 30, 2009

(30) Foreign Application Priority Data
Nov. 10, 2006 (JP) 2006-305420

(51) Int. Cl. B60W 30/14

(52) U.S. Cl. 701/93

(57) ABSTRACT

An automatic operation control apparatus controls an automatic operation of a host vehicle in cooperation with another vehicle. In this apparatus, a nearby vehicle behavior prediction unit predicts the behavior of a vehicle near the host vehicle, a reception unit receives the result of prediction on the behavior of a vehicle, the prediction being made at the other vehicle, and a cruise control plan preparation unit prepares a cruise control plan for the host vehicle using the result of prediction made at the host vehicle and the result of prediction received from the other vehicle.

### BACKGROUND OF THE INVENTION

1. Field of the Invention

The invention relates to an automatic operation control apparatus, an automatic operation control method, a vehicle cruise system, and a method for controlling the vehicle cruise system.

2. Description of the Related Art

A transportation system under which a vehicle is automatically operated is described in, for example, Japanese Patent Application Publication No. 2000-264210 (JP-A-2000-264210). This transportation system controls automatic operations of multiple vehicles in a single-track and closed-cycle automatic vehicle-only lane.

However, under the actual traffic environment, there are both automatically-operated vehicles and manually-operated vehicles. Under this traffic environment, the cruise control plan for an automatically-operated vehicle is influenced by the behaviors of manually-operated vehicles. The behaviors of manually-operated vehicles in a certain region can be recognized at an automatically-operated vehicle. However, the behavior of a manually-operated vehicle that is present outside the certain region may influence the cruise control plan for this automatically-operated vehicle in the future. Accordingly, it is necessary to accurately predict the behaviors of the manually-operated vehicles before preparing the cruise control plan for the automatically-operated vehicle.

### SUMMARY OF THE INVENTION

The invention provides an automatic operation control apparatus, an automatic operation control method, a vehicle cruise system, and a method for controlling the vehicle cruise system, with which a cruise control plan for an automatically-operated vehicle is appropriately prepared even under the traffic environment where there are both automatically-operated vehicles and manually-operated vehicles.

A first aspect of the invention relates to an automatic operation control apparatus that is provided in a host vehicle and that controls an automatic operation of the host vehicle in cooperation with another vehicle. The automatic operation control apparatus includes: a behavior prediction unit that predicts the behavior of a first vehicle that runs near the host vehicle; a behavior prediction result reception unit that receives the result of prediction on the behavior of a second vehicle, the prediction being made at the other vehicle; and a cruise control plan preparation unit that prepares a cruise control plan for the host vehicle using the result of prediction made by the behavior prediction unit and the result of prediction received by the behavior prediction result reception unit.

With the automatic operation control apparatus, the cruise control plan for the host vehicle is prepared with the behavior of the nearby vehicle, which is predicted at the host vehicle and the behavior of the vehicle, which is predicted at the other vehicle, taken into account. Accordingly, the behavior of the nearby vehicle that may exert an influence on the host vehicle is predicted more comprehensively and accurately. As a result, it is possible to appropriately prepare the cruise control plan for the host vehicle with the behavior of the manually-operated vehicle taken into account, even under the traffic environment where there are both automatically-operated vehicles and manually-operated vehicles.

The automatic operation control apparatus may further include a cruise control plan reception unit that receives a cruise control plan for the other vehicle, which is prepared at the other vehicle. The cruise control plan preparation unit may prepare the cruise control plan for the host vehicle using the received cruise control plan for the other vehicle. In this way, the cruise control plan for the host vehicle is prepared with even the behavior of the other vehicle taken into account. As a result, it is possible to prepare a more appropriate cruise control plan for the host vehicle.

The first vehicle of which the behavior is predicted at the host vehicle and the second vehicle of which the behavior is predicted at the other vehicle may be one and the same. The behavior prediction unit may predict the behavior of the first vehicle using the result of prediction received by the behavior prediction result reception unit. In this way, the behavior of the nearby vehicle is predicted using the result of prediction on this nearby vehicle, which is Hat the other vehicle. Accordingly, the behavior of the nearby vehicle is predicted from many view points, which improves the accuracy of the prediction. As a result, it is possible to prepare a more appropriate cruise control plan.

The first vehicle of which the behavior is predicted at the host vehicle and the second vehicle of which the behavior is predicted at the other vehicle may be different from each other. The cruise control plan reception unit may receive the cruise control plan for the other vehicle, which is prepared using the result of prediction on the behavior of the second vehicle, the prediction being made at the other vehicle. In this way, for example, the behavior of the vehicle, which cannot be recognized at the host vehicle, is predicted at the other vehicle, and the cruise control plan for the host vehicle is prepared using the cruise control plan for the other vehicle prepared using the result of prediction on the behavior of the vehicle that cannot be recognized at the host vehicle. Therefore, the influence of the vehicle which cannot be directly recognized at the host vehicle is indirectly taken into account in the preparation of the cruise control plan for the host vehicle by using the cruise control plan for the other vehicle. As a result, it is possible to prepare a more appropriate cruise control plan.

A second aspect of the invention relates to a vehicle cruise system under which multiple automatically-operated vehicles having cruise control plans run. In this system, each of the multiple automatically-operated vehicles includes: a cruise control plan preparation unit that prepares the cruise control plan; a behavior prediction unit that predicts the behavior of a nearby vehicle; and a behavior prediction result reception unit that receives the result of prediction on the behavior of a nearby vehicle, the prediction being made at another automatically-operated vehicle among the multiple automatically-operated vehicles. The behavior prediction unit predicts the behavior of the nearby vehicle using the result of prediction received by the behavior prediction result reception unit, and the cruise control plan preparation unit prepares the cruise control plan using the result of prediction on the behavior of the nearby vehicle.

In the vehicle cruise system, when the behavior of the nearby vehicle is predicted at each of the automatically-operated vehicles, the result of prediction made at the other automatically-operated vehicle is used. Then, the cruise control plan for each automatically-operated vehicle is prepared using the result of the prediction made in the above-described manner. Accordingly, the behavior of the nearby vehicle that may exert an influence on the automatically-operated vehicle is predicted more comprehensively and accurately. As a result, it is possible to prepare an appropriate cruise control plan for the automatically-operated vehicle with the behavior of the manually-operated vehicle taken into account, even under the traffic environment where there are both automatically-operated vehicles and manually-operated vehicles.

The behavior of one and the same vehicle may be predicted at the multiple automatically-operated vehicles. In this way, the behavior of the same nearby vehicle is predicted at the multiple automatically-operated vehicles. Accordingly, the behavior of the nearby vehicle is predicted from many view points, which improves the accuracy of the prediction. As a result, it is possible to prepare a more appropriate cruise control plan.

A third aspect of the invention relates to a vehicle cruise system under which multiple automatically-operated vehicles run according to cruise control plans. In the system, each of the multiple automatically-operated vehicles includes: a cruise control plan preparation unit that prepares the cruise control plan; a behavior prediction unit that predicts the behavior of a nearby vehicle that runs near the host vehicle; and a cruise control plan reception unit that receives the cruise control plan prepared at another automatically-operated vehicle among the multiple automatically-operated vehicles. The cruise control plan preparation unit prepares the cruise control plan for the host vehicle using the result of prediction on the behavior of the nearby vehicle, the prediction being made at the host vehicle, and the cruise control plan for the other automatically-operated vehicle, which is prepared using the result of prediction on the behavior of a nearby vehicle that runs near the other automatically-operated vehicle, the prediction being made at the other automatically-operated vehicle.

In the vehicle cruise system, the cruise control plan for the host vehicle is prepared using the cruise control plan for the other automatically-operated vehicle, which is prepared using the result of prediction on the behavior of the nearby vehicle, the prediction being made at the other automatically-operated vehicle. Accordingly, the behavior of the nearby vehicle that may exert an influence on the automatically-operated vehicle is predicted more comprehensively and accurately. As a result, it is possible to prepare an appropriate cruise control plan for the automatically-operated vehicle with the behavior of the manually-operated vehicle taken into account, even under the traffic environment where there are both automatically-operated vehicles and manually-operated vehicles.

The vehicles of which the behaviors are predicted at the multiple automatically-operated vehicles may be different from each other. In this way, for example, the behavior of the vehicle, which cannot be recognized at one of the automatically-operated vehicles, is predicted at the other automatically-operated vehicle, and the cruise control plan for the one automatically-operated vehicle is prepared using the cruise control plan for the other automatically-operated vehicle prepared using the result of prediction on the behavior of the vehicle, that cannot be recognized at the one automatically-operated vehicle. Therefore, the influence of the Vehicle which cannot be directly recognized at the one automatically-operated vehicle is indirectly taken into account in the preparation of the cruise control plan for the one automatically-operated vehicle by using the cruise control plan for the other automatically-operated vehicle. As a result, it is possible to prepare a more appropriate cruise control plan.

A fourth aspect of the invention relates to an automatic operation control method for controlling an automatic operation of a host vehicle in cooperation with another vehicle. According to the automatic operation control method, the behavior of a first vehicle that runs near the host vehicle is predicted; the result of prediction on the behavior of a second vehicle is received, the prediction being made at the other vehicle; and a cruise control plan for the host vehicle is prepared using the result of prediction on the behavior of the first vehicle and the result of prediction on the behavior of the second vehicle.

A fifth aspect of the invention relates to a method for controlling a vehicle cruise system under which multiple automatically-operated vehicles having cruise control plans run. According to the method, in each of the multiple automatically-operated vehicles, the behavior of a C y vehicle is predicted; the result of prediction on the behavior of a nearby vehicle is received, the prediction being made at another automatically-operated vehicle among the multiple automatically-operated vehicles; the behavior of the nearby vehicle is predicted using the received result of prediction; and the cruise control plan is prepared using the result of prediction on the behavior of the nearby vehicle.

A sixth aspect of the invention relates to a method for controlling a vehicle cruise system under which multiple automatically-operated vehicles run according to cruise control plans. According to the method, in each of the multiple automatically-operated vehicles, the behavior of a nearby vehicle that runs near the host vehicle is predicted; the cruise control plan prepared,.at another automatically-operated vehicle among the multiple automatically-operated vehicles is received; and the cruise control plan for the host vehicle is prepared using the result of prediction on the behavior of the nearby vehicle, the prediction being made at the host vehicle, and the cruise control plan for the other automatically-operated vehicle, which is prepared using the result of prediction on the behavior of a nearby vehicle that runs near the other automatically-operated vehicle, the prediction being made at the other automatically-operated vehicle.

According to the aspects of the invention described above, it is possible to provide the automatic operation control apparatus, the automatic operation control method, the vehicle cruise system, and the method for controlling the vehicle cruise system, with which the cruise control plan for the automatically-operated vehicle is appropriately prepared even under the traffic environment where there are both automatically-operated vehicles and manually-operated vehicles.

### BRIEF DESCRIPTION OF THE DRAWINGS

The foregoing and further objects, features and advantages of the invention will become apparent from the following description of example embodiments with reference to the accompanying drawings, wherein the same or corresponding portions will be denoted by the same reference numerals and wherein:

FIG. 1 is a block diagram showing a vehicle cruise system according to a first embodiment of the invention;

FIG. 2 is a view showing a case where the behavior of a manually-operated nearby vehicle C is monitored at an automatically-operated vehicle A and another automatically-operated vehicle B in the first embodiment of the invention;

FIG. 3 is a block diagram showing a vehicle cruise system according to a second embodiment of the invention;

FIG. 4 is a view showing a case where the behavior of a manually-operated nearby vehicle C is monitored at an automatically-operated vehicle A and the behavior of a manually-operated nearby vehicle D is monitored at an automatically-operated vehicle B in the second embodiment of the invention; and

FIG. 5 is a block diagram showing a vehicle cruise system according to a modified example of the second embodiment of the invention.

### DETAILED DESCRIPTION OF THE EMBODIMENTS

Hereafter, embodiments of the invention will be described with reference to the accompanying drawings. The same reference numerals will be assigned to the same components, and the description concerning the components having the same reference numerals will be provided only once below.

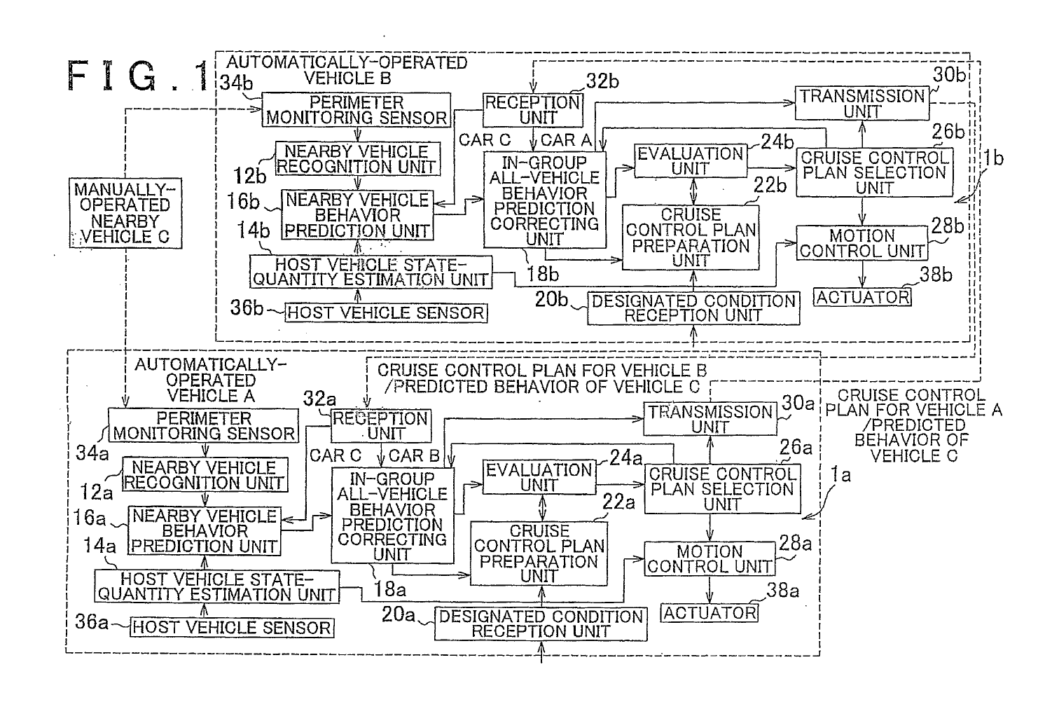

FIG. 1 is a block diagram showing a vehicle cruise system according to a first embodiment of the invention. As shown in FIG. 1, the vehicle cruise system includes multiple automatically-operated vehicles, namely, a vehicle A and a vehicle B. The vehicle A and the vehicle B have the same configuration. Accordingly, only the configuration of the vehicle A will be described below, and description concerning the configuration of the vehicle B will not be provided below. A subscript “a” will be provided to a reference numeral indicating a component of the vehicle A. A component of the vehicle B, which is the same as the corresponding component of the vehicle A, is indicated by a reference numeral that is the same as the reference numeral indicating the corresponding component of the vehicle A, and is provided with a subscript “b”.

The vehicle A is provided with an automatic operation control apparatus (hereinafter, sometimes referred to as a “control apparatus”) 1a shown in FIG. 1. The control apparatus 1a includes a nearby vehicle recognition unit 12a, a host vehicle state-quantity estimation unit 14a, a nearby vehicle behavior prediction unit (behavior prediction unit) 16a, an in-group all-vehicle behavior prediction correcting unit 18a, a designated condition reception unit 20a, a cruise control plan preparation unit 22a, an evaluation unit 24a, a cruise control plan selection unit 26a, a motion control unit 28a, a transmission unit 30a, and a reception unit (behavior prediction result reception unit, cruise control plan reception unit) 32a.

The nearby vehicle recognition unit 12a is connected to a perimeter monitoring sensor 34a that monitors the area around the vehicle A, for example, a millimeter-wave radar, an image sensor, a laser radar, and an ultrasonic-wave sensor. The nearby vehicle recognition unit 12a recognizes a nearby vehicle C which is present near the vehicle A (sometimes referred to as the “host vehicle A”) based on values detected by the perimeter monitoring sensor 34a (for example, information indicated by waves reflected from objects such as the nearby vehicle), and calculates the information concerning the nearby vehicle C, for example, the relative distance, angle and speed between the host vehicle A and the nearby vehicle C.

The host vehicle state-quantity estimation unit 14a is connected to a host vehicle sensor 36a that detects the state quantity of the host vehicle A. The host vehicle sensor 36a is, for example, a yaw-rate sensor, a vehicle speed sensor, an acceleration sensor, a steering angle sensor, a white line detection sensor, and a GPS. The host vehicle state-quantity estimation unit 14a calculates an estimate value of the state quantity of the vehicle A (yaw-rate of the vehicle A, lateral position of the vehicle A within a lane, lateral velocity of the vehicle A, yaw angle of the vehicle A with respect to the road line shape, position of the vehicle A, etc.) based on the values detected by the host vehicle sensor 36a, using a vehicle model incorporated in the software.

The nearby vehicle behavior prediction unit 16a obtains the information concerning the nearby vehicle calculated by the nearby vehicle recognition unit 12a, and the estimate value of the state quantity of the vehicle A calculated by the host vehicle state-quantity estimation unit 14. Then, the nearby vehicle behavior prediction unit 16a calculates the history information concerning the position of the vehicle A, the history information concerning the relative position between the vehicle A and the nearby vehicle C, the relative speed between the vehicle A and the nearby vehicle C, etc. based on the obtained information, and estimates the history information concerning the position of the nearby vehicle C, and the current state (speed, acceleration, yaw-angle with respect to the road line shape, etc) of the nearby vehicle C based on the calculated information. Thus, it is possible to estimate the positional relationship between the vehicle A and the nearby vehicle C, and the tendencies in the cruising manner of the nearby vehicle C (vehicle-to-vehicle distance, vehicle speed, acceleration/deceleration, and driver's preference, for example, inhibitions against changing lanes). The nearby vehicle behavior prediction unit 16a obtains the information concerning the shape of the road (whether the number of lanes increases/decreases, whether the road and another road join together, whether the road branches off into multiple roads, whether there is a curve in the road ahead, the road line shape, etc.) on which the vehicle A is running based on information from a navigation system, infrastructure installation, etc. Then, the nearby vehicle behavior prediction unit 16a tentatively predicts the behavior that may be exhibited by the nearby vehicle C in the near future (for example, the behavior that may be exhibited until the nearby vehicle C reaches a point approximately several hundred meters ahead), based on the history information concerning the position of the nearby vehicle C, the current state of the nearby vehicle C, and the information concerning the road shape. This prediction is made using a driver model that is formed in advance based on the tendencies in the cruising manner of the nearby vehicle C.

The nearby vehicle behavior prediction tit 16a receives, via the reception unit 32a, the result of prediction on the future behavior of the nearby vehicle C, which is made at the other automatically-operated vehicle B in the same manner as described above. Then, the nearby vehicle behavior prediction unit 16a predicts the behavior of the nearby vehicle C more accurately using the tentative result of prediction on the behavior of the nearby vehicle C and the result of prediction on the behavior of the nearby vehicle C received from the vehicle B.

The reception unit 32a receives the cruise control plan for the other automatically-operated vehicle B prepared at the vehicle B and the result of prediction on the behavior of the nearby vehicle C made at the vehicle B via vehicle-to-vehicle communication using a 2.4 GHz radio wave. The result of prediction on the behavior of the nearby vehicle C is transmitted to the nearby vehicle behavior prediction unit 16a, and the cruise control plan for the vehicle B is transmitted to the in-group all-vehicle behavior prediction correcting unit 18a.

The in-group all-vehicle behavior prediction correcting unit 18a receives the selected cruise control plan for the vehicle A from the cruise control plan selection unit 26a, the cruise control plan for the vehicle B from the reception unit 32a, and the result of prediction on the behavior of the vehicle C from the nearby vehicle behavior prediction unit 16a. Then, the in-group all-vehicle behavior prediction correcting unit 18a superimpose the selected cruise control plan for the vehicle A, the cruise control plan for the vehicle B and the predicted behavior of the vehicle C with each other on the time axis. Then, the in-group all-vehicle behavior prediction correcting unit 18a corrects the cruise control plans for the vehicles A and B, and the predicted behavior of the vehicle C in a manner such that problematic points (for example, overlap between two vehicles) are eliminated.

The designated condition reception unit 20a receives signals indicating the conditions for the entire cruise, which are designated by a driver. For example, the designated condition reception unit 20a receives signals indicating the designated destination, travel time, degree of priority given to the fuel efficiency, plan for rest, etc.

The cruise control plan preparation unit 22a prepares multiple tentative cruise control plans (including paths that will be taken by the host vehicle A and speed patterns) that may be implemented in the near future (for example, until the vehicle A reaches a point several hundred meters ahead). Requests from the driver and the cruise environment condition are taken into account in preparation of the tentative cruise control plans. For example, when the driver gives priority to reduction in travel time, the cruise control plan preparation unit 22a prepares multiple cruise control plans according to which frequent lane changes are permitted to allow the vehicle A to reach the destination earlier. When the driver gives priority to high fuel efficiency, the cruise control plan preparation unit 22a prepares multiple cruise control plans according to which a brake is applied less frequently and the vehicle change lanes less frequently to take a smoothly extending path. The cruise control plan preparation unit 22a prepares the cruise control plans based on the corrected cruise control plans for the vehicle A and the vehicle B and the corrected prediction on the behavior of the vehicle C that are indicated by signals transmitted from the in-group all-vehicle behavior prediction correcting unit 18a.

The evaluation unit 24a evaluates each of the tentatively prepared multiple cruise control plans based on predetermined indexes (for example, safety, environmental-friendliness (based on the fuel efficiency), and comfort). The predicted behavior of the nearby vehicle C and the cruise control plan for the automatically-operated vehicle B that are indicated by the signals transmitted from the in-group all-vehicle behavior prediction correcting unit 1a are taken into account in evaluation of the cruise control plans. When there is a problematic point, for example, when safety is not ensured at a portion of the cruise control plan, the cruise control plan preparation unit 22a corrects the problematic point and the evaluation unit 24a evaluates the corrected cruise control plan again.

The cruise control plan selection unit 26a selects the highly-evaluated cruise control plan as the cruise control plan to be implemented from among the multiple cruise control plans based on the results of evaluations made by the evaluation unit 24a. For example, when the driver gives higher priority to the safety, the cruise control plan selection unit 26a selects the cruise control plan having higher safety.

The motion control unit 28a prepares command values given to an actuator 38a based on the selected cruise control plan (path which will b taken by the host vehicle A, and speed pattern). The estimate value of the state quantity of the host vehicle A is taken into account in preparation of the command values. The command values are prepared in a manner such that the position and speed of the host vehicle A at each time point within the predetermined prediction duration are accurately achieved.

The actuator 38a includes actuators for an engine, a brake, an electric power steering system, etc. and ECUs that control the engine, the brake, the electric power steering system, etc. The actuator 38a receives signals indicating a throttle valve opening amount command value, a brake pressure command value, a steering torque command value, etc. from the motion control unit 28a, and controls the engine, the brake, the electric power steering system, etc.

The transmission unit 30a transmits signals indicating the cruise control plan for the vehicle A selected by the cruise control plan selection unit 26a, and the predicted behavior of the vehicle C received from the in-group all-vehicle behavior prediction correcting unit 18a to the other automatically-operated vehicle B via vehicle-to-vehicle communication using, for example, a 2.4 GHz radio wave.

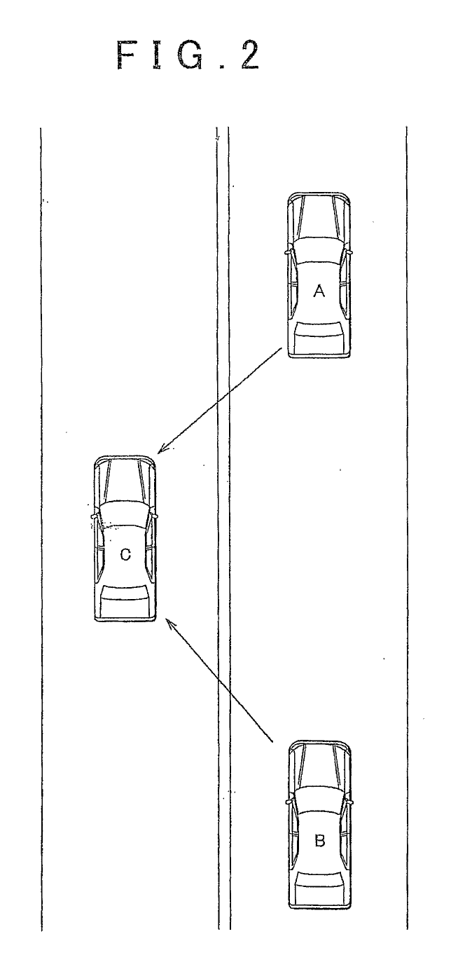

Next, the operation control over the automatically-operated vehicle A executed by the automatic operation control apparatus 1a that operates in cooperation with the automatically-operated vehicle B will be described. As shown in FIG. 2, the case where the behavior of the manually-operated nearby vehicle C is monitored at the automatically-operated vehicle A and the automatically-operated vehicle B will be described.

First, the nearby vehicle recognition unit 12a recognizes the nearby vehicle C that is present near the host vehicle A based on the value detected by the perimeter monitoring sensor 34a, and calculates the information concerning the nearby vehicle C such as the relative distance, angle, and speed between the host vehicle A and the nearby vehicle C. The host vehicle state-quantity estimation unit 14a calculates an estimate value of the state quantity of the host vehicle A (position of the host vehicle A, yaw-rate of the host vehicle A, lateral position of the host vehicle A within a lane, lateral velocity of the host vehicle A, yaw angle of the host vehicle A with respect to the road line shape, etc.) based on the values detected by the host vehicle sensor 36a.

Next, the nearby vehicle behavior prediction unit 16a predicts the behavior of the nearby vehicle C that may be exhibited during the predetermined prediction duration (for example, several tens of seconds) from the current moment. The nearby vehicle behavior prediction unit 16a obtains the information concerning the nearby vehicle C calculated by the nearby vehicle recognition unit 12a, and the estimate value of the state quantity of the host vehicle A calculated by the host vehicle state-quantity estimation unit 14a. Then, the nearby vehicle behavior prediction unit 16a calculates the history information concerning the position of the host vehicle A, the history information concerning the relative position between the host vehicle A and the nearby vehicle C, the relative speed between the host vehicle A and the nearby vehicle C, etc. based on the obtained information, and estimates the history information concerning the position of the nearby vehicle C, and the current state (speed, acceleration, yaw-angle with respect to the road line shape, etc) of the nearby vehicle C based on the calculated information. Thus, it is possible to estimate the positional relationship between the host vehicle A and the nearby vehicle C, and the tendencies in the cruising manner of the nearby vehicle C (vehicle-to-vehicle distance, vehicle speed, acceleration/deceleration, and driver's preference, for example, inhibitions against changing lanes). The nearby vehicle behavior prediction unit 16a obtains the information concerning the shape of the road (whether the number of lanes increases/decreases, whether the road and another road join together, whether the road branches off into multiple roads, whether there is a curve in the road ahead, the road line shape, etc.) on which the host vehicle A is running based on information from the navigation system, the infrastructure installation, etc. Then, the nearby vehicle behavior prediction unit 16a predicts the behavior that may be exhibited by the nearby vehicle C in the near future (for example, until the nearby vehicle C reaches a point several hundred meters ahead), based on the history information concerning the position of the nearby vehicle C, the current state of the nearby vehicle C, and the information concerning the road shape. This prediction is made using the driver model that is formed in advance based on the tendencies in the cruising manner of the nearby vehicle C.

The nearby vehicle behavior prediction unit 16a receives, via the reception unit 32a, the result of prediction on the behavior that may be exhibited by the nearby vehicle C in the near future, which is made at the other automatically-operated vehicle B in the same manner as described above. Then, the nearby vehicle behavior prediction unit 16a predicts the behavior of the nearby vehicle C more accurately using the tentative result of prediction on the behavior of tie nearby vehicle C and the result of prediction on the behavior of the nearby vehicle C received from the vehicle B.

For example, in the case shown in FIG. 2, when a front blinker of the vehicle C is off but a rear blinker thereof normally blinks, it is determined that the probability that the vehicle C will change lanes is high. Then, the behavior of the nearby vehicle C is predicted with a greater importance put on the result of prediction on the behavior of the vehicle C, which is made at the automatically-operated vehicle B.

Then, the in-group all-vehicle behavior prediction correcting unit 18a receives signals indicating the selected cruise control plan for the vehicle A from the cruise control plan selection unit 26a, the cruise control plan for the vehicle B from the reception unit 32a, and the predicted behavior of the vehicle C from the nearby vehicle behavior prediction unit 16a. Then, the in-group all-vehicle behavior prediction correcting unit 18a superimpose the selected cruise-control plan for the vehicle A, the cruise control plan for the vehicle B and the predicted behavior of the vehicle C with each other on the time axis. Then, the in-group all-vehicle behavior prediction correcting unit 18a corrects the cruise control plans for the vehicles A and B and the predicted behavior of the vehicle C in a manner such that problematic points (for example, overlap between two vehicles) are eliminated.

After receiving signals indicating the conditions for the entire cruise designated by the driver, the cruise control plan preparation unit 22a prepares multiple tentative cruise control plans (including paths that will be taken by the host vehicle and speed patterns) that may be implemented in the near future (for example, until the vehicle reaches a point several hundred meters ahead). Requests from the driver and the cruise environment condition are taken into account in preparation of the tentative cruise control plans. At this time, the designated condition reception unit 20a prepares the cruise control plans based on the corrected cruise control plans for the vehicles B and A and the corrected prediction on the behavior of the vehicle C that are indicated by the signals received from the in-group all-vehicle behavior prediction correcting unit 18a.

Then, the evaluation unit 24a evaluates each of the prepared multiple cruise control plans based on the predetermined indexes (for example, safety, environmental-friendliness (based on the fuel efficiency), and comfort). The predicted behavior of the nearby vehicle C and the cruise control plan for the automatically-operated vehicle B are taken into account in evaluation of the cruise control plans. When there is a problematic point, for example, when safety is not ensured at a portion of the cruise control plan, the cruise control plan preparation unit 22a corrects the problematic point and the evaluation unit 24a evaluates the corrected cruise control plan again.

Next, the cruise control plan selection unit 26a selects the highly-evaluated cruise control plan as the cruise control plan to be implemented from among the multiple cruise control plans based on the results of evaluations made by the evaluation unit 24a. For example, when the driver gives priority to safety, the cruise control plan having higher safety is selected.

Next, the motion control unit 28a prepares command values given to an actuator 38a based on the selected cruise control plan (path which will be taken by the host vehicle, and speed pattern). The estimate value of the state quantity of the host vehicle is taken into account in preparation of the command values. The command values are prepared in a manner such that the position and speed of the host vehicle at each time point within the predetermined prediction duration are accurately achieved.

The actuator 38a receives signals indicating a throttle valve opening amount command value, a brake pressure command value, a steering torque command value, etc. from the motion control unit 28a, and controls the engine, the brake, the electric power steering system, etc. In this way, the automatic operation of the vehicle A is controlled.

Meanwhile, signals indicating the cruise control plan for the vehicle A selected by the cruise control plan selection unit 26a, and the predicted behavior of the vehicle C received from the in-group all-vehicle behavior prediction correcting unit 18a are transmitted from the transmission unit 30a to the automatically-operated vehicle B.

As described above the automatic operation control apparatus 1a according to the first embodiment of the invention is able to prepare the cruise control plan for the host vehicle A with the behavior of the nearby vehicle C predicted at the host vehicle A and the automatically-operated vehicle B taken into account. Accordingly, it is possible to predict the behavior of a nearby vehicle that may exert an influence on the host vehicle A more comprehensively and accurately. Therefore, even under the traffic environment where there are both the automatically-operated vehicle A and the manually-operated vehicle C, it is possible to appropriately prepare the cruise control plan for the automatically-operated vehicle A with the behavior of the manually-operated vehicle C taken into account.

Also, the cruise control plan for the automatically-operated vehicle A is prepared using the cruise control plan for the other automatically-operated vehicle B. Therefore, the behavior of the automatically-operated vehicle B is also taken into account in preparation of the cruise control plan for the vehicle A. As a result, it is possible to prepare a more appropriate cruise control plan for the host vehicle A.

In addition, the vehicle of which the behavior is predicted at the host vehicle. A and the vehicle of which the behavior is predicted at the other automatically-operated. vehicle B are one and the same, and the nearby vehicle behavior prediction unit 16a predicts the behavior of the vehicle C using the result of prediction received through the reception unit 32a. Therefore, when the behavior of the nearby vehicle C is predicted, the behavior of the vehicle C that is predicted at the automatically-operated vehicle B is used. Accordingly, the behavior of the vehicle C is predicted from many viewpoints, which improves the accuracy of the prediction on the behavior of the vehicle C. As a result, it is possible to prepare a more appropriate cruise control plan for the host vehicle A.

The same process is performed at the automatically-operated vehicle B. Accordingly, with the vehicle cruise system including the vehicle A and the vehicle B, it is possible to predict the behavior of the nearby vehicle that may exert an influence on the automatically-operated vehicles more comprehensively and accurately. Therefore, even under the traffic environment where there are both the automatically-operated vehicle and the manually-operated vehicle, it is possible to appropriately prepare the cruise control plan for the automatically-operated vehicle with the behavior of the manually-operated vehicle taken into account.

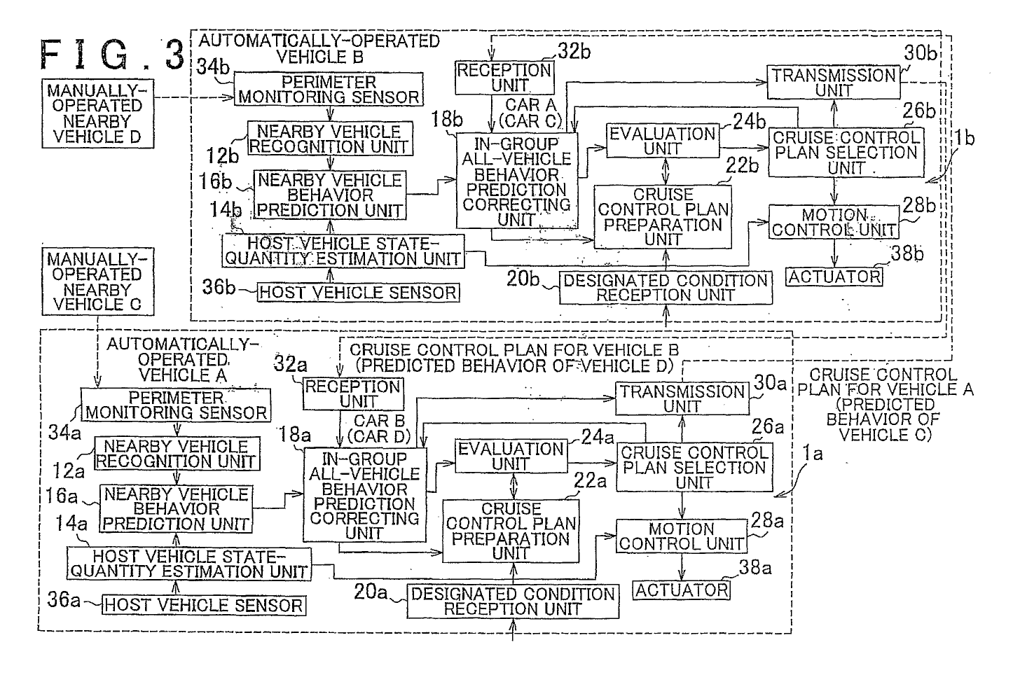

Next, a vehicle cruise system according to a second embodiment of the invention will be described. FIG. 3 is a block diagram showing the vehicle cruise system according to the second embodiment of the invention. As shown in FIG. 3, the cruise control system includes multiple automatically-operated vehicles, namely, a vehicle A and a vehicle 3. The vehicle A and the vehicle B have the same configuration. Accordingly, only the configuration of the vehicle A will be described below, and description concerning the configuration of the vehicle B will not be provided below. A subscript “a” will be provided to a reference numeral indicating a component of the vehicle A. A component of the vehicle B, which is the same as a corresponding component of the vehicle A, is indicated by a reference numeral that is the same as the reference numeral indicating the corresponding component of the vehicle A and provided with a subscript “b”.

In the second embodiment of the invention, the vehicle A is provided with an automatic operation control apparatus (hereinafter, sometimes referred to as a “control apparatus”) 1a. The control apparatus 1a according to the second embodiment of the invention has the same configuration as that of the control apparatus 1a according to the first embodiment of the invention except the process performed by the nearby vehicle behavior prediction unit 16a.

According to the first embodiment of the invention, the behavior of the vehicle C is predicted at the vehicle A and the vehicle B. Therefore, a signal indicating the behavior of the vehicle C predicted at the vehicle B, which is received by the reception unit 32a is transmitted to the nearby vehicle prediction unit 16a. The nearby vehicle behavior prediction unit 16a predicts the behavior of the vehicle C with the behavior of the vehicle C predicted at the vehicle B taken into account. In contrast, according to the second embodiment of the invention, the vehicle of which the behavior is predicted at the vehicle A is different from the vehicle of which the behavior is predicted at the vehicle B. Accordingly, the nearby vehicle behavior prediction unit 16a predicts the behavior of the vehicle C without taking the result of prediction made at the automatically-operated vehicle B into account.

Meanwhile, the cruise control plan preparation unit 22b of the vehicle B prepares the cruise control plan-with the predicted behavior of the vehicle D taken into account. Therefore, the behavior of the vehicle D is indirectly taken into account in preparation of the cruise control plan for the vehicle A by using the cruise control plan for the automatically-operated vehicle B, which is received by the reception unit 32a of the vehicle A. A signal indicating the predicted behavior of the vehicle D may be transmitted from the transmission unit 30b of the vehicle B to the reception unit 32a, and the behavior of the vehicle D may be taken into account in preparation of the cruise control plan for the vehicle A.

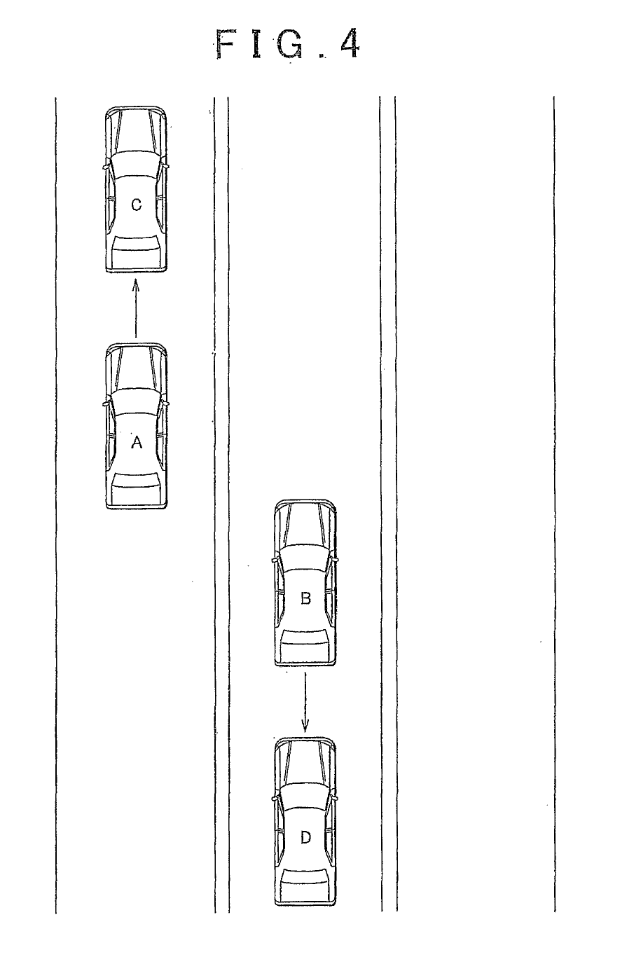

FIG. 4 shows the case where the behaviors of the manually-operated vehicles C and D are predicted at the automatically-operated vehicle A and B, respectively, in the second embodiment of the invention. As shown in FIG. 4, the vehicle A runs in the left-hand lane and the vehicle B runs in the right-hand lane in a two-lane road. The vehicle A is ahead of the vehicle B. The manually-operated vehicle D runs behind the vehicle B, and the manually-operated vehicle C runs ahead of the vehicle A. At this time, the vehicle C cannot be recognized at the vehicle B, and the vehicle D cannot be recognized at the vehicle A.

Under this situation, for example, when the speed of the vehicle D is considerably higher than the speed of the vehicle B, the cruise control plan according to which the vehicle B moves into the left-hand lane is prepared at the vehicle B. At this time, preferably, the cruise control plan according to which the vehicle A does not move into the right-hand lane is prepared at the vehicle A because the vehicle A may contact the vehicle D that cannot be recognized at the vehicle A.

According to the second embodiment of the invention, the cruise control plan preparation unit 22a prepares the cruise control plan with the cruise control plan for the vehicle B received through the reception unit 32a taken into account. This cruise control plan is prepared with the predicted behavior of the vehicle D taken into account. Therefore, receiving the cruise control plan according to which the vehicle B moves into the left-side lane makes it possible to predict that the high-speed vehicle D will come from behind and prepare the cruise control plan with the possibility that the high-speed vehicle D will come from the behind taken into account. As described above, the influence of the vehicle D which cannot be directly recognized at the host vehicle A is indirectly taken into account in the preparation of the cruise control plan by using the cruise control plan for the automatically-operated vehicle B. As a result, it is possible to prepare a more appropriate cruise control plan.

If a signal indicating the predicted behavior of the vehicle D is received by the reception unit 32a and the cruise control plan for the vehicle A is prepared with the predicted behavior of the vehicle D taken into account, it is possible to prepare the cruise control plan with the influence of the vehicle D more effectively taken into account.

While the invention has been described with reference to the embodiments thereof, it is to be understood that the invention is not limited to the embodiments or constructions. To the con the invention is intended to cover various modifications and equivalent arrangements within the scope of the invention.

For example, according to the first embodiment of the invention, the behavior of only the nearby vehicle C is monitored at the vehicle A and the vehicle B. Alternatively, the behaviors of multiple nearby vehicles may be monitored at the same time at the vehicle A and the vehicle B. Also, the number of automatically-operated vehicles is not limited to two, and may be three or more.

According to the second embodiment of the invention, the behavior of only the nearby vehicle C is monitored at the vehicle A, and the behavior of only the nearby vehicle D is monitored at the vehicle B. Alternatively, the behaviors of multiple vehicles may be monitored at each of the vehicles A and B. Also, the number of automatically-operated vehicles is not limited to two, and may be three or more.

Also, the first embodiment and the second embodiment of the invention may be combined with each other. The behavior of the same vehicle may be monitored at the vehicle A and the vehicle B while the behaviors of the different vehicles may be monitored at the vehicle A and the vehicle B.

The cruise control plan for the vehicle B may be prepared by the cruise control plan preparation unit 22a of the vehicle A, and the cruise control plan for the vehicle A may be prepared by the cruise control plan preparation unit 22b of the vehicle B. Then, these cruise control plans may be exchanged via vehicle-to-vehicle communication. In this way, it is possible to prepare more accurate cruise control plans.

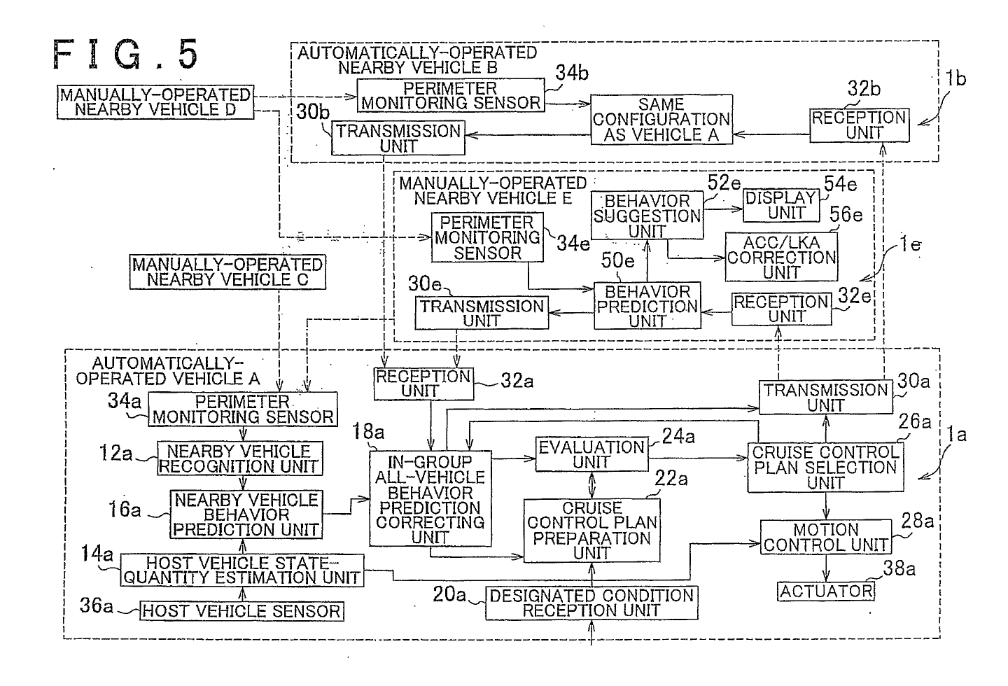

As shown in FIG. 5, if there is a manually-operated nearby vehicle E that is able to be communicated with the other vehicles, a vehicle cruise system including the vehicle E may be formed. FIG. 5 is a block diagram showing a vehicle cruise system according to a modified example of the second embodiment of the invention. As shown in FIG. 5, in the cruise control system, an operation support control apparatus 1e includes a perimeter monitoring sensor 34e, a behavior prediction unit 50e, a behavior suggestion unit 52e, a display unit 54e, an ACC/LKA correction unit 56e, a reception unit 32e, and a transmission unit 30e.

The perimeter monitoring sensor 34e is a sensor that monitors the area around the vehicle E, for example, a millimeter-wave radar, an image sensor, a laser radar, and an ultrasonic-wave sensor. The perimeter monitoring sensor 34e detects the nearby vehicle D. The reception unit 32e receives signals indicating the cruise control plan for the vehicle A, and the predicted behaviors of the vehicles D and E of which the accuracy has been improved at the vehicle A. The behavior prediction unit 50e predicts the behavior of the vehicle E based on the information detected by sensors mounted in the vehicle B such as a vehicle speed sensor, an accelerator pedal operation amount sensor, a brake pedal operation amount sensor, and a steering angle sensor, the behavior of the vehicle E which is predicted at the vehicle A and received through the reception unit 32e, and the information from the vehicle near the vehicle E. Then, the behavior prediction unit 50e predicts the behavior of the vehicle D based on the information from the sensors mounted in the vehicle 1, the predicted behavior of the vehicle E, and the information from the vehicle A.

The transmission unit 30e transmits signals indicating the predicted behaviors of the vehicles D and B (the predicted presence distribution with respect to time) to the vehicle A. When the vehicle E, which is not an automatically-operated vehicle, is provided with an operation assist device, for example, the display unit 54e, an ACC (Adaptive Cruise Control) unit or a LKA (Lane Keep Assist) unit, the behavior suggestion unit 52e prepares the behavior plan appropriate for the driver and the cruise assist device. The display unit 54e displays the operation manner appropriate for the driver who is performing a manual operation. The ACC/LKA correction unit 56e makes a target speed correction or produces a steering torque so that the vehicle E is operated in the operation manner appropriate for the cruise assist device, for example, the ACC unit or the LKA unit.

As described abode, incorporating the manually-operated vehicle E that is able to communicate with the other vehicles into the vehicle cruise system makes it possible to predict the behaviors of the nearby vehicles C, D and E that may exert an influence on the vehicles A and B more comprehensively and accurately. Therefore, even under the traffic environment where there are both automatically-operated vehicles and manually-operated vehicles, it is possible to prepare an appropriate cruise control plan for the automatically-operated vehicle with the behavior of the manually-operated vehicle taken into account. Also, it is possible to suggest the desirable direction in which the vehicle E should be operated and the desirable operation for the vehicle E.

What is claimed is:

1. An automatic operation control apparatus that is provided in a host vehicle and that controls an automatic operation of the host vehicle in cooperation with another vehicle, comprising:
a behavior prediction unit that predicts a behavior of a first vehicle that runs near the host vehicle;
a behavior prediction result reception unit that receives a result of prediction on a behavior of a second vehicle, the prediction being made at the other vehicle; and
a cruise control plan preparation unit that prepares a cruise control plan for the host vehicle using a result of prediction made by the behavior prediction unit and the result of prediction received by the behavior prediction result reception unit.

2. The automatic operation control apparatus according to claim 1, further comprising:
a cruise control plan reception unit that receives a cruise control plan for the other vehicle, which is prepared at the other vehicle,
wherein
the cruise control plan preparation unit prepares the cruise control plan for the host vehicle using the received cruise control plan for the other vehicle.

3. The automatic operation control apparatus according to claim 2,
wherein
the first vehicle of which the behavior is predicted at the host vehicle and the second vehicle of which the behavior is predicted at the other vehicle are different from each other, and
the cruise control plan reception unit receives the cruise control plan for the other vehicle, which is prepared using the result of prediction on the behavior of the second vehicle, the prediction being made at the other vehicle.

4. The automatic operation control apparatus according to claim 1,
wherein
the first vehicle of which the behavior is predicted at the host vehicle and the second vehicle of which the behavior is predicted at the other vehicle are one and the same, and
the behavior prediction unit predicts the behavior of the first vehicle using the result of prediction received by the behavior prediction result reception unit.

5. The automatic operation control apparatus according to claim 4,
wherein
the other vehicle is a manually-operated vehicle that is communicable with the host vehicle, and
the other vehicle and the second vehicle are one and the same.

6. The automatic operation control apparatus according to claim 1
wherein
the other vehicle is an automatically-operated vehicle, and
the second vehicle is a vehicle that runs near the other vehicle.

7. A vehicle cruise system under which multiple automatically-operated vehicles having cruise control plans run, wherein
each of the multiple automatically-operated vehicles includes:
a cruise control plan preparation unit that prepares the cruise control plan;
a first behavior prediction unit that predicts a behavior of a nearby vehicle; and
a behavior prediction result reception unit that receives a result of prediction on a behavior of a nearby vehicle, the prediction being made at another automatically-operated vehicle among the multiple automatically-operated vehicles,
wherein
the first behavior prediction unit predicts the behavior of the nearby vehicle using the result of prediction received by the behavior prediction result reception unit, and
the cruise control plan preparation unit prepares the cruise control plan using the result of prediction on the behavior of the nearby vehicle.

8. The vehicle cruise system according to claim 7,
wherein
the behavior of one and the same vehicle is predicted at the multiple automatically-operated vehicles.

9. The vehicle cruise system according to claim 7, further comprising:
a manually-operated vehicle that is communicable with at least one of the plurality of automatically-operated vehicles,
wherein
the behavior prediction result reception unit further receives a result of prediction on a behavior of the manually-operated vehicle,
the manually-operated vehicle includes:
a second behavior prediction unit that predicts a behavior of the manually-operated vehicle using the result of prediction that is predicted at least one of the multiple automatically-operated vehicles,
wherein
the cruise control plan preparation unit prepares the cruise control plan using the result of prediction received by the behavior prediction result reception unit.

10. A vehicle cruise system under which multiple automatically-operated vehicles run according to cruise control plans wherein:
each of the multiple automatically-operated vehicles includes:
a cruise control plan preparation unit that prepares the cruise control plan;
a behavior prediction unit that predicts a behavior of a nearby vehicle that runs near a host vehicle; and
a cruise control plan reception unit that receives the cruise control plan prepared at another automatically-operated vehicle among the multiple automatically-operated vehicles,
wherein
the cruise control plan preparation unit prepares the cruise control plan for the host vehicle using a result of prediction on the behavior of the nearby vehicle, the prediction being made at the host vehicle, and the cruise control plan for the other automatically-operated vehicle, which is prepared using a result of prediction on a behavior of a nearby vehicle that runs near the other automatically-operated vehicle, the prediction being made at the other automatically-operated vehicle.

11. The vehicle cruise system according to claim 10, wherein
the vehicles of which the behaviors are predicted at the multiple automatically-operated vehicles are different from each other.

12. An automatic operation control method for controlling an automatic operation of a host vehicle in cooperation with another vehicle, comprising:
predicting a behavior of a first vehicle that runs near the host vehicle;
receiving a result of prediction on a behavior of a second vehicle, the prediction being made at the other vehicle; and
preparing a cruise control plan for the host vehicle using a result of prediction on the behavior of the first vehicle and the result of prediction on the behavior of the second vehicle.

13. A method for controlling a vehicle cruise system under which multiple automatically-operated vehicles having cruise control plans run, comprising:
in each of the multiple automatically-operated vehicles, predicting a behavior of a nearby vehicle;
receiving a result of prediction on a behavior of a nearby vehicle, the prediction being made at another automatically-operated vehicle among the multiple automatically-operated vehicles;
predicting the behavior of the nearby vehicle using the received result of prediction; and
preparing the cruise control plan using the result of prediction on the behavior of the nearby vehicle.

14. A method for controlling a vehicle cruise system under which multiple automatically-operated vehicles run according to cruise control plans, comprising:
in each of the multiple automatically-operated vehicles,
predicting a behavior of a nearby vehicle that runs near a host vehicle;
receiving the cruise control plan prepared at another automatically-operated vehicle among the multiple automatically-operated vehicles; and
preparing the cruise control plan for the host vehicle using a result of prediction on the behavior of the nearby vehicle, the prediction being made at the host vehicle, and the cruise control plan for the other automatically-operated vehicle, which is prepared using a result of prediction on a behavior of a nearby vehicle that runs near the other automatically-operated vehicle, the prediction being made at the other automatically-operated vehicle.

15. The automatic operation control apparatus according to claim 1,
wherein
the other vehicle is a manually-operated vehicle that is communicable with the host vehicle, and
the other vehicle and the second vehicle are one and the same.
